(19) United States
(12) Patent Application Publication
(10) Pub. No.: US 2026/0298003 A1
(43) Pub. Date: Oct. 1, 2026

(54) DOOR CLOSER

(71) Applicant: DORMAKABA DEUTSCHLAND GMBH, Ennepetal (DE)

(72) Inventors: Alexander HELLWIIG, Ennepetal (DE); Sven BUSCH, Dortmund (DE); Lothar BALTES, Ennepetal (DE); Gökhan AKGÜN, Ennepetal (DE)

(21) Appl. No.: 19/474,057

(22) PCT Filed: Apr. 8, 2024
(86) PCT No.: PCT/EP2024/059443

§ 371 Date: Oct. 9, 2025

(30) Foreign Application Priority Data
Apr. 10, 2023 (EP) 23167232.0

(51) Int. Cl. E05F 1/10

(52) U.S. Cl. CPC E05F 1/105; E05Y 2201/10; E05Y 2400/337; E05Y 2600/50; E05Y 2900/132

(57) ABSTRACT

A door closer for closing a door, including a housing and an output shaft supported therein, designed for fastening a lever arrangement, a mechanical energy storage device in the housing which drives the output shaft to rotate, with the energy storage device preferably being a spring, a module including at least one battery and/or a data transmission unit for data transmission, with the housing having a first end face, which is to face a hinge of the door when the door closer is mounted, with the housing having a second end face, which is opposite the first end face, and with the module being arranged next to the second end face of the housing.

### CROSS-REFERENCE TO RELATED APPLICATIONS

This application is a 35 U.S.C. § 371 National Stage patent application of PCT/EP2024/059443, filed on 8 Apr. 2024, which claims the benefit of European patent application 23167232.0, filed on 10 Apr. 2023, the disclosures of which are incorporated herein by reference in their entirety.

### TECHNICAL FIELD

The present disclosure relates to a door closer for closing a door.

### BACKGROUND

EP 3 315 704 A1 shows a system for monitoring safety-relevant functions of a door closer. A combination of position and acceleration signals is used to verify whether the door closer has been broken or tampered with. For example, it can be detected whether a lever connected to the output shaft of the door closer has been unhooked.

### SUMMARY

The present disclosure provides a door closer that can be mounted in a space-saving and flexible manner and enables a door to be used safely.

This is achieved by providing the features of the independent claim. The dependent claims relate to preferred configurations of the disclosure.

Information such as “left”, “right”, “forwards” are to be understood from the perspective of an observer standing in front of an installed door closer.

The disclosure shows a door closer for closing a door. The door closer has a housing. The housing is in particular made of metal, preferably cast. An output shaft of the door closer is supported in the housing so as to be rotatably movable. The output shaft can be rotated about an axis of rotation.

The output shaft is designed for fastening a lever arrangement. According to a first mounting variant, the door closer can be fastened on the door. The lever arrangement forms the connection to the wall. For example, a slide rail of the lever arrangement is fastened to the wall. In the context of the present disclosure, the term “wall” also includes the door frame. According to a second mounting variant, the door closer can be fastened to the wall. The lever arrangement then forms the connection from the door closer to the door, i.e. to the door leaf. For example, the sliding rail of the lever arrangement is fastened on the door, i.e. on the door leaf.

The door closer comprises a mechanical energy storage device. The mechanical energy storage device is designed in particular as a spring. A spiral spring is particularly preferred. The mechanical energy storage device is arranged in the housing and drives the output shaft to rotate into a closing direction of rotation.

As will be described in detail, a transmission unit can be located between the energy storage device and the output shaft in order to convert between the movement of the output shaft and the movement of the energy storage device.

The output shaft rotates in a “closing direction of rotation”, in particular when the door closer is properly installed to close a door and the door closes. When the door is opened, the output shaft rotates in the opposing direction, also known as the opening direction of rotation.

The door closer is preferably designed without a drive such that it is in particular not a door drive operated in a motorised manner.

It can be provided that the door closer comprises hydraulic oil to dampen the closing movement.

According to the disclosure, the door closer comprises a module. The module has at least one battery or a housing arrangement for a battery and/or a data transmission unit. The data transmission unit is preferably designed for wireless electronic data transmission. For example, the data transmission unit can transmit data by means of NB-IoT and/or Bluetooth. The data transmission unit preferably comprises at least one antenna.

The at least one battery is preferably designed to supply power to the data transmission unit. A battery is understood to mean both primary batteries and rechargeable secondary batteries. It may be that the module comprises a plurality of batteries. The housing arrangement can be designed for electrically contacting the plurality of batteries.

It is particularly preferably provided that the data transmission unit is designed to transmit a battery status of the at least one battery, i.e. for example a charge status.

The housing has a first end face that is to face a hinge of the door when the door closer is mounted. Furthermore, a second end face of the housing is defined, which is opposite the first end face. Accordingly, the second end face faces a main closing edge of the door. The module is arranged next to the second end face of the housing. This ensures a space-saving arrangement of the module and the positioning of the module does not affect the positioning of the first end face or the output shaft.

Next to the second end face means that the module is arranged directly or at a distance to the side of the second end face. This means that the module is located at least close to the second end face.

The module is preferably connected at least indirectly to the housing. The door closer is therefore preferably a mechanical unit.

The module in particular makes it possible to supply power and/or data to any monitoring elements—for example a sensor unit, which will be described later—in the door closer, thereby enabling the door to be operated safely.

The door closer is preferably designed without a connection to an external electrical power supply.

The door closer is designed to be arranged in a right-sided and left-sided arrangement on a door or wall. In the left-sided arrangement, the hinges of the door are on the left of the door closer; in the right-sided arrangement, the hinges of the door are on the right of the door closer. The first end face must always face the hinges. In the context of this disclosure, the terms “left-sided arrangement” and “right-sided arrangement” are understood to mean a “left-sided arrangement” and “right-sided arrangement” of the door closer on the door or wall.

The module is arranged next to the second end face of the housing in both a right-sided and left-sided arrangement. This means that the module is always arranged facing away from the hinges of the door. The module is preferably connected at least indirectly to the housing here. This makes it possible to arrange the module remote from the hinges when changing from a right-sided arrangement to a left-sided arrangement or vice versa on the door closer. The door closer is also designed as a compact unit. The at least indirect connection of the housing and the module preferably takes place in the door closer.

The door closer preferably comprises corresponding connecting means for the permanent arrangement of the module next to the second end face of the housing. The module and the housing are in particular connected at least indirectly in a form-fitting and/or force-fitting manner by means of the connecting means. This allows the module to be arranged so as to be reversibly detachable from the housing.

It can be provided that an arrangement of the module and the arrangement of the housing differ from one another in the right-sided and left-sided arrangement. This means that the module and the housing are moved independently of one another when changing from the right-sided to the left-sided arrangement. To this end, the connection is in particular broken by the connecting means in order to then reconnect the module and the housing at least indirectly in a different arrangement. The door closer preferably comprises various connecting means by way of which the module can be arranged in different arrangements in relation to the housing. The connecting means can therefore be used as desired. At least one first connecting means is used in a left-sided arrangement, while another, second connecting means is not used in a left-sided arrangement. Accordingly, the second connecting means is used in a right-sided arrangement, but not the first connecting means.

The door closer is preferably designed such that the housing is arranged on a door in a first housing orientation in a left-sided arrangement and in a second housing orientation, which is rotated relative to the first orientation, in a right-sided arrangement. For example, the door closer has two connections on the output shaft to which the lever arrangement can be fastened as desired. The transmission unit can also be designed accordingly, as is known, for example, from WO2011/009556 A1.

Additionally or alternatively, it can be provided in the context of the present disclosure that the door closer is designed such that the module is arranged in a first module orientation in a left-sided arrangement (of the door closer on a door) and in a second module orientation, which is rotated relative to the first module orientation, in a right-sided arrangement (of the door closer on a door). This means that in particular not only the housing with the energy storage device and the output shaft is rotated when changing from a left-sided to a right-sided arrangement, but also the module.

To fasten the module in the rotated module orientation, corresponding form-fitting and/or force-fitting connecting means, in particular the first and second connecting means, can be provided in the door closer according to the disclosure.

For example, it can be provided that the data transmission unit is arranged facing away from the housing. This allows data to be sent or received as undisturbed as possible by the metal housing. It is preferably provided that the data transmission unit is arranged facing away from the housing in both a left-sided and right-sided arrangement. This is achieved in particular by rotating the module from the first module orientation to the second module orientation.

It can be provided that the module comprises the housing arrangement for the battery. The battery can be received in the housing arrangement with electrical contact. To replace the battery, the battery can be removed from the housing arrangement and replaced with a charged battery.

The data transmission unit is preferably fixedly connected to the housing arrangement. Here, a fixed connection means in particular a form-fitting, force-fitting or materially-bonded connection. For example, the data transmission unit can be screwed to the housing arrangement. The connection between the data transmission unit and the housing arrangement preferably remains intact when changing from the right-sided to the left-sided arrangement.

It can be provided that the housing arrangement comprises an opening for replacing the battery. A user can reach into the housing arrangement through the opening to remove or insert the battery. The door closer is preferably designed such that the opening maintains an opening orientation perpendicular to the door in a right-sided and left-sided arrangement. For example, the opening always points forwards when a door closer is mounted. This means that the battery can always be easily replaced in both a right-sided and a left-sided arrangement.

In particular, in order to maintain the orientation of the opening, the door closer can be designed such that the module and the housing are moved independently of one another when changing from the right-sided to the left-sided arrangement. This means that the at least indirect connection between the housing and the module is detached. It is preferably provided here that the rotation of the housing from the first housing orientation to the second housing orientation and the rotation of the first module orientation to the second module orientation are different.

For example, it can be provided that the door closer is designed such that the housing is rotated by 180° relative to the first housing orientation both about a longitudinal axis and about an axis of rotation perpendicular to the longitudinal axis in the second housing orientation.

For example, in the second module orientation, the module is rotated, in particular by 180°, about an axis of rotation perpendicular to the longitudinal axis. The module is in particular only rotated about an axis of rotation perpendicular to the longitudinal axis in the second module orientation.

In order to achieve this in particular, the door closer preferably comprises various connecting means, which are only used in the right-sided arrangement or in the left-sided arrangement. The connecting means can therefore be used as desired. The connecting means can be the first and the second connecting means.

The door closer comprises a mounting plate and the housing of the door closer is fastened to the mounting plate. The mounting plate comprises fastening elements, in particular designed as holes, for screwing the mounting plate to the door or wall and for fastening the housing to the mounting plate. If necessary, additional elements can be fastened to the mounting plate.

The mounting plate, the housing and the module are designed such that the housing can be fastened on the mounting plate at different points, in particular more to the left and more to the right, without rotating the mounting plate. This makes it possible for the mounting plate to have a length that corresponds to the length of the housing and to the length of the module, but does not have to have the length of the housing plus twice the length of the module.

In the left-sided, i.e. more left, arrangement of the housing on the mounting plate, the module is located to the right next to the housing, in particular above the mounting plate. In the right-sided, i.e. more right, arrangement of the housing on the mounting plate, the module is located to the left next to the housing, in particular above the mounting plate.

The module is in particular located completely above the mounting plate in the left-sided and right-sided arrangement and therefore does not protrude laterally beyond the mounting plate.

The mounting plate and the housing are in particular designed such that the housing can be fastened on the mounting plate in an orientation on the left side, i.e. more to the left, and in an orientation on the right side, i.e. more to the right, rotated at least once by 180°.

Two halves can be defined on the housing, with the first half being assigned to the first end face and the second half being assigned to the second end face. The output shaft is located in the first half and therefore closer to the first end face than to the second end face. The energy storage device is preferably located at least partially in the second half and therefore closer to the second end face than to the first end face. The energy storage device is therefore arranged between the output shaft and the second end face.

It is preferably provided that the door closer comprises a panel. The panel covers at least the housing and the module of the door closer on at least one side, in particular forwards.

The panel preferably covers the housing and the module on a plurality of sides.

The module is in particular located, preferably completely, under the panel.

The module is particularly preferably arranged, in particular fastened, on the inside of the panel. In the case of fastening, the panel can comprise the connecting means, in particular the first and the second connecting means, with which the module is indirectly connected to the housing. The panel can in particular comprise the connecting means with which the module can be connected optionally in a left-sided or right-sided arrangement.

The connecting means can be designed as a module receptacle.

Both a module receptacle for the left-sided arrangement and a module receptacle for the right-sided arrangement are provided.

The panel is preferably fastened to the mounting plate.

The panel preferably has opposing end walls.

The end walls are preferably connected to one another via two opposing side walls. It is in particular provided that the two end walls and the two side walls together form the base body of the panel. This base body of the panel can preferably be closed by means of a removable cover of the panel.

The module can preferably be arranged, in particular fastened, on one of the end walls of the panel, particularly preferably optionally on both end walls of the panel. In the case of fastening, the end face of the panel, preferably the end faces of the panel, can comprise the connecting means with which the module is indirectly connected to the housing.

The module can preferably be arranged on both sides of the housing—due to the optional more left-sided arrangement and more right-sided arrangement of the housing in relation to the mounting plate. For this reason, there is preferably a module receptacle on each of the two end walls of the panel for fastening the module.

Additionally or alternatively to the arrangement on the panel, the module can preferably be arranged, in particular fastened, on the mounting plate. The module can preferably be arranged, in particular fastened, on two opposing sides of the mounting plate. This means that the connecting means can be designed for indirect connection to the housing on the mounting plate. The mounting plate can in particular comprise the connecting means with which the module can be connected, in particular fastened, optionally in a left-sided or right-sided arrangement.

The connecting means of the mounting plate can in particular be designed as at least one hole or a plurality of holes. The module can, for example, be fastened in the holes using fastening means, e.g. screws. The mounting plate preferably comprises first connecting means, in particular a hole or a plurality of holes for fastening in a left-sided arrangement, and second connecting means, in particular a hole or a plurality of holes for fastening in a right-sided arrangement.

The module can preferably be detached in a non-destructive manner, preferably without tools, from the panel and/or mounting plate, in particular for battery replacement.

The module preferably has a module circuit board. The module is fastened in particular by means of this module circuit board. The module circuit board is in particular fastened to the panel, preferably the module receptacle.

The module particularly preferably has the housing arrangement. This housing arrangement is in turn preferably fastened to the module circuit board.

The module is preferably fastened at a distance from the mounting plate. This distance can prove to be advantageous in the event of a fire if the mounting plate is heated via the door, as the distance prevents the heat from being transferred directly to the module and thus to the batteries. The distance is in particular chosen so that the at least one battery is at least 5 mm away from the mounting plate.

The panel, in particular the end walls, is preferably at least partially made of plastic. This allows the data transmission unit to transmit data without interference and/or, in the event of a fire, the connection to the module can melt particularly well such that the module can sink down.

The door closer preferably comprises a sensor that is connected to the module for data and/or power transmission. The connection can be designed as a cable connection, for example.

The door closer preferably comprises a sensor unit, which is preferably designed and arranged to detect an actual angle of rotation of the output shaft. The sensor unit comprises the sensor and an encoder.

The encoder is preferably arranged or designed on the output shaft. The encoder is preferably a separate component that is arranged, in particular fastened, to the output shaft. Alternatively, the output shaft can also be designed in such manner that it acts as an encoder.

The sensor of the sensor unit is preferably designed and arranged for identifying the encoder, in particular without contact. The sensor is particularly preferably designed to detect a position and/or a rotation and/or an acceleration of the encoder. It is in particular provided that the combination of sensor and encoder makes it possible to detect the actual angle of rotation of the output shaft.

The sensor unit makes it possible to detect the position and/or movement of the output shaft by simple means. As the encoder is located directly on the output shaft, the position and/or movement can be detected very precisely. This allows conclusions to be drawn about the proper functioning of the door closer, which means that the door can be operated safely. For example, it can be detected whether the door is open or closed. It can also be detected whether the lever arrangement is damaged or tampered with, as described in detail in connection with an evaluation unit.

The arrangement of the encoder directly or only indirectly via an encoder fastening on the output shaft also has the advantage that the encoder and thus the entire sensor arrangement can be added to existing door closers. The necessary approvals usually already exist for such existing door closers such that no or only minor changes to the approval are required by adding the sensor unit. This is due in particular to the fact that the relatively small encoder does not affect the mechanics inside the door closer and therefore the basic function of the door closer, namely to close the door securely, is not affected by the sensor unit.

The axis of rotation of the output shaft preferably intersects the sensor and/or the encoder. This ensures that an arrangement of sensor and encoder is as close as possible to the axis of rotation, enabling precise detection of the actual angle of rotation in the tightest of spaces.

The sensor is particularly preferably arranged symmetrically to the axis of rotation, whereby the axis of rotation intersects the sensor, in particular in the centre of the sensor. Furthermore, it is preferably provided that the encoder is arranged symmetrically to the axis of rotation, whereby the axis of rotation intersects the centre of the encoder.

It is preferably provided that the sensor is arranged on a sensor receiving device. The sensor receiving device preferably positions the sensor on the end face of the output shaft.

The sensor receiving device preferably comprises a bracket. The bracket is in particular in one piece. The bracket is preferably made of plastic.

It is preferably provided that the sensor receiving device comprises a sensor circuit board. The sensor is arranged on the sensor circuit board and the sensor circuit board is preferably fastened to the bracket.

The sensor receiving device, in particular the bracket, is preferably fastened, in particular screwed, to the mounting plate. This makes it possible to position the sensor relatively fixedly and accurately.

Additionally or alternatively, the sensor receiving device can rest against and/or be fastened to the housing of the door closer. The fastening relative to the housing in particular enables very precise positioning of the sensor relative to the encoder, which is located on the output shaft.

The bracket preferably has a bracket projection. This extends around the output shaft such that the output shaft protrudes into the bracket projection. The bracket projection is preferably supported axially on the inside against the housing. This means that the bracket rests against the housing. The bracket projection preferably clamps radially on the outside of an inner surface of the housing, whereby the bracket is fastened to the housing.

Additionally or alternatively, the sensor receiving device can rest against the inside of the panel. The bracket is preferably clamped between the panel and the housing. This provides a further option for positioning the sensor receiving device and thus the sensor accurately and with as little play as possible.

The sensor receiving device preferably comprises at least one fastening spring, in particular as an integral part of the bracket, in order to apply pretension to the clamped bracket.

The panel preferably comprises at least one bracket receptacle for the bracket. The panel preferably comprises fastening tabs, with the fastening tabs being recessed on the bracket receptacle for inserting the bracket. The panel can be fastened to the mounting plate, in particular screwed, by means of these fastening tabs.

The bracket receptacle is preferably doubled on the inside of one of the two side walls of the panel. This double design of the bracket receptacle is used in particular when the housing is changed between a left-sided arrangement and a right-sided arrangement.

It is preferably provided that the encoder comprises a permanent magnet and the sensor is a magnetic sensor, in particular a Hall sensor.

The permanent magnet is preferably designed in such manner that the north pole forms one end of the permanent magnet and the south pole forms the other end of the permanent magnet. When the encoder rotates, the north and south poles change position in space. For example, the permanent magnet is round and the north pole and the south pole each form one half of the permanent magnet.

The encoder is preferably fastened, in particular screwed, to the end face of the output shaft. The output shaft particularly preferably has a fastening receptacle on at least one side, in particular on both sides. This fastening receptacle is in particular a bore coaxial to the axis of rotation of the output shaft. The fastening receptacle particularly preferably has an internal thread.

An encoder fastening is preferably inserted, in particular screwed, into the fastening receptacle. The encoder fastening has a fastening head. The encoder is preferably fastened, in particular adhered, to the fastening head.

In a preferred embodiment, the fastening head has a form-fitting element that ensures the precise positioning of the encoder. In addition, it is preferably provided that the fastening head has an edge surrounding the encoder such that the edge also ensures that the encoder is fastened to the fastening head in the precise position.

The encoder fastening is preferably made of plastic.

The output shaft is preferably exposed on two opposing sides of the housing and is used to optionally fasten the lever arrangement to one side or the other side. It is provided that the lever arrangement can be fastened to both sides of the output shaft, but—as described by the term “optional”—is only actually fastened to one of the two sides. Which choice is made depends on whether the door closer is located in a left-sided or right-sided arrangement.

In the case of a specific door closer in a first installation situation, a first side of the output shaft is therefore used to fasten the lever arrangement. The encoder is preferably fastened at least indirectly on the other, second side of the output shaft. In principle, this other, second side is also suitable for fastening the lever arrangement.

In the case of a specific door closer in a second installation situation, the second side of the output shaft is therefore used to fasten the lever arrangement. The encoder is preferably fastened at least indirectly on the other, first side of the output shaft. In principle, this other, first side is also suitable for fastening the lever arrangement.

The output shaft in particular has a connection, preferably a polygon, particularly preferably square, on each of the two opposing, exposed sides for fastening the lever arrangement.

Since the encoder can preferably be mounted on either of the connections, the sensor receiving device must also preferably be mountable on both sides of the output shaft.

It can therefore be provided that the sensor is arranged next to one side of the housing in a right-sided arrangement and next to an opposing side of the housing in a left-sided arrangement.
The panel in particular encloses the sensor arrangement.
It may be that openings into which the bracket can engage have different depths around the output shaft on the two sides. It may therefore be that different brackets are provided for the two sides. It may be that each of the brackets is/are designed for axial contact with an axle bearing closure and/or that each of the brackets is/are designed for radial contact with the openings.

As described, the encoder is preferably located on the output shaft and rotates with the output shaft. In contrast, the sensor is installed stationary, but is preferably located in the immediate vicinity of the encoder, in particular on the end face of the output shaft.

As already mentioned, the door closer can comprise the transmission unit, which is located in the housing of the door closer and is designed to transmit the movement between the output shaft and the energy storage device. The transmission unit is in particular designed for reciprocal transmission between the rotational movement of the output shaft and the linear movement of the energy storage device.

The transmission unit preferably has a cam that rotates with the output shaft. The cam sits in particular on the output shaft and can be an integral component of the output shaft. The cam is in particular heart-shaped and therefore has two convex flanks which converge in a depression.

The transmission unit preferably comprises a closing piston that is guided on the cam in a rolling or sliding manner. On the closing piston is located in particular a closing piston roller, which rolls on the cam. The closing piston is guided in particular in a linearly movable manner in the housing and is driven by the energy storage device. If the closing piston moves in one direction, it charges the energy storage device. When the energy storage device is discharged, the closing piston is pushed in the opposing direction by the energy storage device.

The output shaft preferably rotates within a first angle range to open and close the door. This first angle range must be distinguished from a second angle range in which the output shaft can rotate, but which is not occupied by the output shaft as long as the door closer is properly installed on the door and in operation. If the door closer is not installed, the output shaft rotates in particular into the second angle range, as this discharges the energy storage device as far as possible.

The closing piston is preferably guided on one flank of the cam. The flank runs into a depression of the cam, with the closing piston, in particular with its closing piston roller, resting against the flank and not against the depression in the closed position of the output shaft. The closing piston moves along the flank in the direction of the depression when the actual angle of rotation moves into the second angle of rotation range.

When installing the door closer, the lever arrangement is mounted on the output shaft and the output shaft is rotated to the first angle range via the lever arrangement. If the door closer is installed, the lever arrangement is always connected to the output shaft on one side and to the wall or door on the other. As a result, the output shaft can rotate at most up to the limit between the first angle range and the second angle range, but does not rotate into the second angle range. This means that the limit between the first angle range and the second angle range represents a “closed position” of the output shaft. In this closed position of the output shaft, the associated door is closed. The angle for the closed position of the output shaft is referred to as the “closing angle of rotation”.

If damage now occurs to the door closer or the lever arrangement or, for example, the lever arrangement is tampered with, in particular if the lever arrangement is detached, the output shaft rotates from the first angle range into the second angle range.

The disclosure further comprises a monitoring system comprising the described door closer and the electronic evaluation unit.

As will be described in detail, the evaluation unit does not have to be located in the door closer, but can also be located at any other point. The closing angle of rotation is stored in the evaluation unit, which means that the limit between the first angle range and the second angle range is known in the evaluation unit. This closing angle of rotation can, for example, be a value fixedly stored in the evaluation unit or a value that can be changed depending on the installation situation of the door closer. It is also possible to define the closing angle of rotation in the evaluation unit by way of a corresponding learning process after the door closer has been installed.

The evaluation unit is preferably designed to generate a message if the actual angle of rotation is in the second angle range; the generation of the message is therefore dependent on whether or not the actual angle of rotation is in the second angle range.

The message is, for example, a signal that the evaluation unit generates and uses within itself, for example to issue a warning, and/or that the evaluation unit transmits to another unit. Based on the message that is generated in the evaluation unit, it can be concluded that the damage or tampering described above has occurred. This in turn leads to the conclusion that the door may not be properly closed by means of the door closer, which is relevant in particular for fire doors.

It is preferably provided that the door closer is designed to rotate the output shaft into the second angle range as soon as a connection—in particular the lever arrangement—between the output shaft and the door or between the output shaft and the wall is detached. It should be noted in particular that the lever arrangement connects the output shaft to the door if the door closer is fastened to the wall or the lever arrangement connects the output shaft to the wall if the door closer is fastened to the door.

In addition, it is preferably provided that the output shaft in its closed position, i.e. when the door is closed, is driven by the energy storage device to rotate into the closing direction of rotation. This means in particular that the output shaft is still driven by the energy storage device in its closed position and the energy storage device is not completely discharged. This ensures in particular that the energy storage device can still rotate the output shaft from the closed position into the second angle range.

When the output shaft rotates in the closing direction of rotation, the pretension of the energy storage device or the energy stored in the energy storage device decreases, with it being provided in particular that a minimum pretension is not present in the energy storage device in the closed position, but only in the second angle range.

The output shaft can preferably be rotated in the opening direction of rotation to charge the energy storage device when the door is opened. The door is opened in particular by manual actuation of the door, in particular by a user.

The monitoring system described particularly preferably comprises the lever arrangement. The lever arrangement can also be regarded as a component of the door closer. The lever arrangement is fastened to one side of the output shaft and the encoder is fastened to the other side of the output shaft. This means that the side of the output shaft not used for the lever arrangement can be used for the sensor arrangement.

The lever arrangement preferably comprises a slide rail and a lever, with one end of the lever being guided in the slide rail and the other end of the lever being able to be fastened to the output shaft.

Alternatively, the lever arrangement preferably comprises a linkage, with the linkage having two rods rotatably connected to one another. One end of the linkage can be fastened to the output shaft. The other end of the linkage can be fastened to the wall so as to be rotatable if the door closer is mounted on the door or can be fastened to the door so as to be rotatable if the door closer is mounted on the wall.

As already mentioned, the evaluation unit is designed in particular to relay the generated message to an external unit. This unit can be a building control unit and/or a cloud and/or a server and/or a terminal and/or a mobile terminal. The terminal is a computer, for example. The mobile terminal is a smartphone or tablet, for example.

By relaying the message from the evaluation unit to the external unit, a corresponding warning can be generated in the unit in any desired manner. For example, the mobile terminal can be used to indicate that a certain door closer has been damaged or tampered with.

According to an optional first variant, it is provided that the evaluation unit generating the message is arranged as an internal evaluation unit in the region of the door, in particular in the door closer. The expression “in the door closer” is in particular to be understood in that the evaluation unit is located underneath the panel of the door closer. Alternatively, the evaluation unit can also be located next to the door closer, for example in the region of the door. The evaluation unit can be arranged on the module circuit board together with the data transmission unit.

According to an optional second variant, it is provided that the evaluation unit generating the message is outsourced as an external evaluation unit, with the door closer being designed to send the actual angle of rotation or a value derived therefrom to the external evaluation unit—in particular by means of the data transmission unit.

If the evaluation unit is designed as an internal evaluation unit, the at least one battery of the module is preferably also provided to supply power to the evaluation unit.

If it is an external evaluation unit, the data transmission unit of the module can send the actual angle of rotation or a value derived therefrom to the external evaluation unit. If it is an internal evaluation unit, the generated message can be sent to the external unit, i.e. for example the server or the terminal, via the transmission unit.

The advantage of the disclosure is also achieved by providing a method according to the disclosure for mounting a door closer according to an independent claim. The method is in particular used to mount the door closer described above, in particular a door closer according to one of the apparatus claims. The door closer described above can also be mountable by means of the method according to the disclosure.

The method according to the disclosure comprises at least the following steps:
arranging the housing on a door or a wall such that a first end face of the housing faces a hinge of the door,
arranging the module next to a second end face of the housing, which is opposite the first end face.

### BRIEF DESCRIPTION OF THE DRAWINGS

The disclosure will now be explained in more detail using an exemplary embodiment, for which is shown:

FIG. 1 a schematic representation of a monitoring system with an external evaluation unit and a door closer according to the disclosure in accordance with an exemplary embodiment,

FIG. 1a a schematic representation of a variant of the monitoring system with internal evaluation unit in the door closer according to the disclosure in accordance with the exemplary embodiment,

FIG. 2 a perspective view of the door closer according to the disclosure in accordance with the exemplary embodiment,

FIG. 3 an exploded representation of the door closer according to the disclosure in accordance with the exemplary embodiment,

FIG. 4 components inside a housing of the door closer according to the disclosure in accordance with the exemplary embodiment,

FIG. 5 a schematic sectional view of a detail of the door closer according to the disclosure in accordance with the exemplary embodiment,

FIG. 6 a perspective view of the door closer according to the disclosure in accordance with the exemplary embodiment without panel,

FIG. 7 the section A-A marked in FIG. 2,

FIG. 8 a detail from FIG. 7,

FIG. 9 an end face of an output shaft of the door closer according to the disclosure in accordance with the exemplary embodiment,

FIG. 10 a sensor receiving device of the door closer according to the disclosure in accordance with the exemplary embodiment,

FIG. 11 a detail of the panel of the door closer according to the disclosure in accordance with the exemplary embodiment,

FIG. 12 a variant of the sensor receiving device of the door closer according to the disclosure in accordance with the exemplary embodiment,

FIG. 13 a perspective view of the door closer according to the disclosure in accordance with the exemplary embodiment with the cover open,

FIG. 14 a sectional view of a module in the door closer according to the disclosure in accordance with the exemplary embodiment,

FIG. 15 a perspective view of the module of the door closer according to the disclosure in accordance with the exemplary embodiment,

FIG. 16 a variant for configuring the module of the door closer according to the disclosure in accordance with the exemplary embodiment,

FIG. 17 a sectional view of the variant of the module from FIG. 16,

FIG. 18 a variant for fastening the module of the door closer according to the disclosure in accordance with the exemplary embodiment,

FIG. 19 different representations of the left-sided arrangement and right-sided arrangement of the housing of the door closer according to the disclosure in accordance with the exemplary embodiment, with different components being hidden for the sake of clarity, and

FIG. 20 a method according to the disclosure.

### DETAILED DESCRIPTION OF THE DRAWINGS

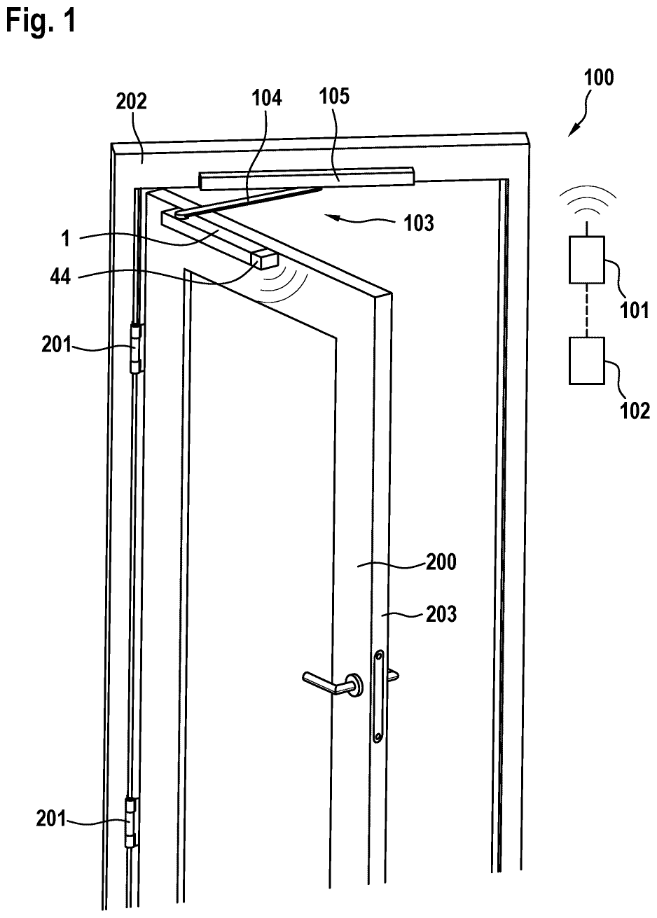

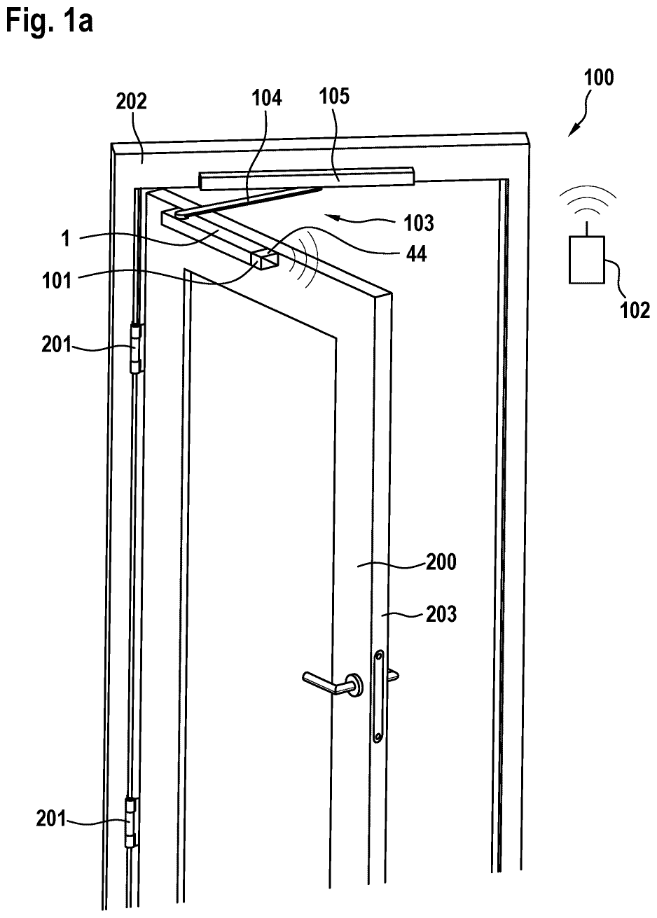

A door closer 1 according to the disclosure is described below on the basis of FIGS. 1 to 19. Said door closer can be a component of a monitoring system 100.

According to FIG. 1, the monitoring system 100 comprises an evaluation unit 101. In FIG. 1, the evaluation unit 101 is located outside the door closer 1 as an external evaluation unit 101. Alternatively, the evaluation unit 101 can also be a component of the door closer 1 as an internal evaluation unit 101—according to FIG. 1a.

Furthermore, the monitoring system 100 comprises an external unit 102, for example a server, a cloud, a building control unit, a terminal or a mobile terminal. The evaluation unit 101 and the external unit 102 are connected to one another for data transmission.

The door closer 1 comprises a data transmission unit 44. In FIG. 1, a wireless data transmission from this data transmission unit 44 to the external evaluation unit 101 is represented purely schematically. If the evaluation unit 101 is located inside the door closer 1 as an internal evaluation unit according to FIG. 1a, the data transmission unit 44 transmits wirelessly to the external unit 102.

The monitoring system 100 further comprises a lever arrangement 103. A lever 104 and a slide rail 105 are components of the lever arrangement 103.

According to FIG. 1, the door closer 1 is located on a door 200. Accordingly, the slide rail 105 is fastened to a wall 202. The lever 104 connects the door closer 1 with the slide rail 105 on the wall 202. As the schematic representation in FIG. 1 shows, the wall 202 is synonymous with the frame of the door 200.

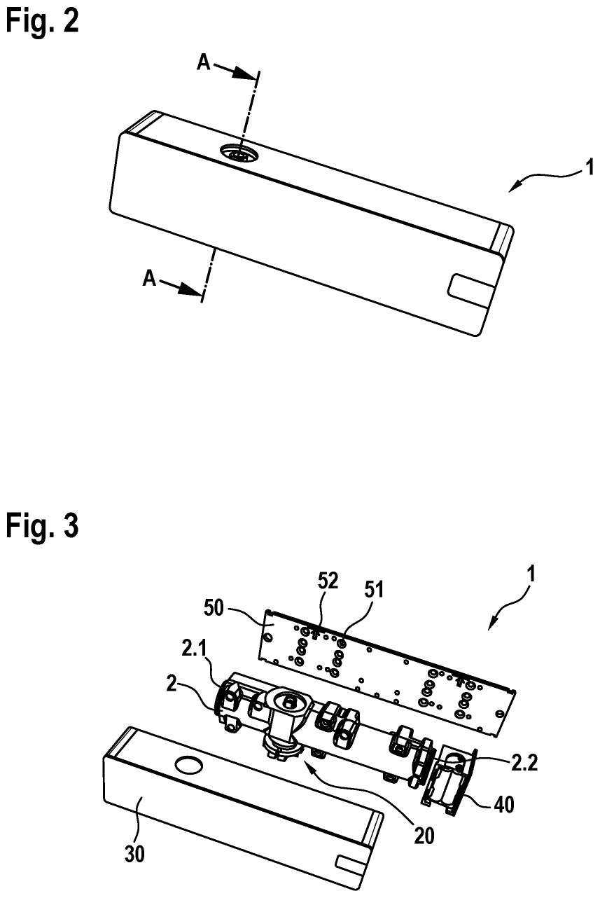

The door 200 is supported so as to be rotatably movable relative to the wall 202 via two hinges 201. The door closer 1 in FIG. 1 or FIG. 2 is a door closer 1 that is located in a left-sided arrangement.

Unless otherwise stated in detail, reference is always made below to all figures:

The door closer 1 has a housing 2. A first end face 2.1 and an opposing second end face 2.2 are defined on the housing 2 (see FIG. 3).

In addition to the housing 2, the door closer 1 has a mounting plate 50 and a panel 30. The housing 2 is fastened on the mounting plate 50. The mounting plate 50 comprises fastening elements 51 in the form of holes. The mounting plate 50 is used to fasten the door closer 1 to the door 200 or the wall 202. In addition, according to the disclosure, the door closer 1 comprises a module 40. FIG. 3 shows an exploded representation of these four assemblies, namely housing 2, module 40, panel 30 and mounting plate 50. It can also be seen here that the module 40 is arranged next to the second end face 2.2.

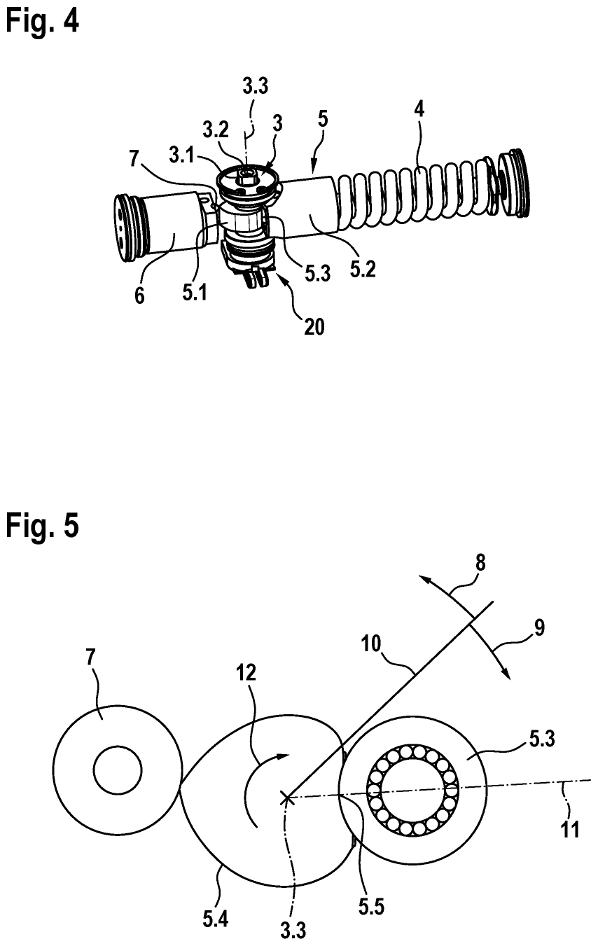

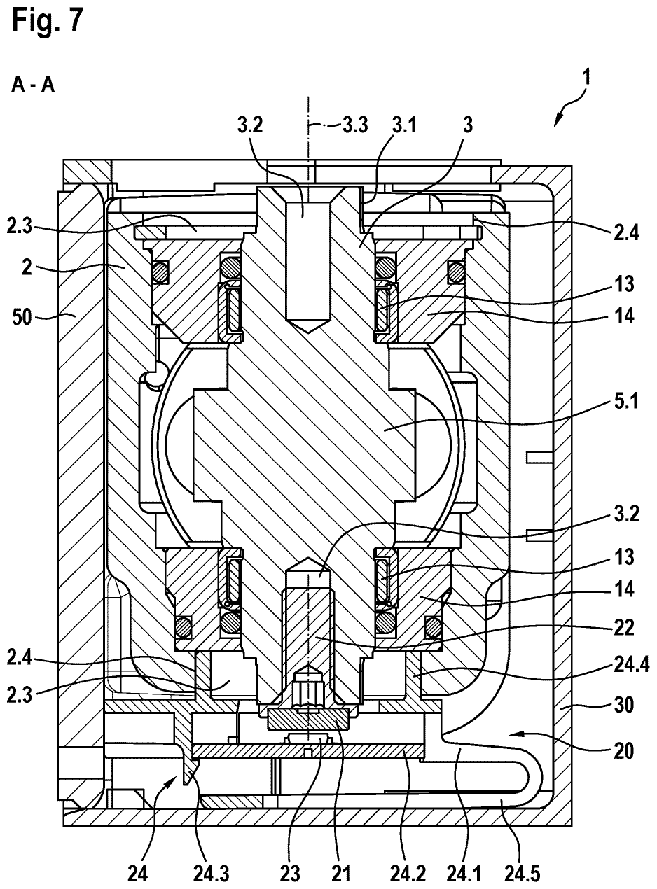

Furthermore, the door closer 1 has an output shaft 3. The output shaft 3 is supported in the housing 2 so as to be rotatably movable and is driven by an energy storage device 4 in the form of a spiral spring (see FIG. 4). As FIG. 7 in particular shows, the output shaft 3 is supported on both sides by means of an axle bearing 13. The axle bearing 13 is secured with a screwed-in axle bearing closure 14. This axle bearing closure 14 is regarded as a component of the housing 2.

The output shaft 3 is exposed on both sides (see FIG. 7) such that in principle the lever arrangement 103 can be fastened to the output shaft 3 on both sides. However, only one side of the output shaft 3 is actually used to fasten the lever arrangement 103. The respectively other side of the output shaft 3 is used to position a sensor unit 20 in the door closer 1.

The output shaft 3 has a polygon 3.1 on each of its two sides, in the form of a square. The output shaft 3 can be rotated about an axis of rotation 3.3. Coaxial to the axis of rotation 3.3, the output shaft 3 has a fastening receptacle 3.2 on both sides. The fastening receptacle 3.2 is in the form of a hole with an internal thread and is used to fasten the lever arrangement 103 or an encoder 21 of the sensor unit 20, as will be described in detail.

In FIG. 4, the housing 2 is hidden such that the internal components can be seen. Accordingly, the door closer 1 comprises a transmission unit 5 inside the housing 2. This transmission unit 5 has a cam 5.1 that rotates with the output shaft 3. A closing piston 5.2 is guided on the cam 5.1 in a rolling manner by means of a closing piston roller 5.3. The closing piston roller 5.3 rolls on a flank 5.4 of the cam 5.1. The schematic sectional view in FIG. 5 shows this in detail.

FIGS. 4 and 5 also show that a damping piston 6 is guided in the housing 2 in a linearly movable manner. This damping piston 6 also rolls on the cam 5.1 with a damping piston roller 7.

The cam 5.1 has two opposing flanks 5.4, which converge in a depression 5.5. The flanks 5.4 run convexly such that a heart-shaped cam 5.1 results.

In the representations according to FIGS. 4 and 5, the energy storage device 4 is in a discharged state. The closing piston roller 5.3 rests against the cam 5.1 inside the depression 5.5. This relative position between cam 5.1 and closing piston roller 5.3 only occurs if the door closer 1 is not yet installed or if the connection via the lever arrangement 103 is interrupted due to damage or tampering. However, if the door closer 1 is installed correctly and the connection between the door closer 1 and the wall 202 is ensured via the lever arrangement 103, the output shaft 3 is rotated relative to the representation in FIG. 5 such that the closing piston roller 5.3 rests outside the depression 5.5.

FIG. 5 illustrates purely schematically a closing direction of rotation 12 in which the output shaft 3 is rotated when the door 200 is closed. An opening direction of rotation runs counter to this closing direction of rotation 12 marked.

Furthermore, FIG. 5 shows purely by way of exemplary a closing angle of rotation 10 of the output shaft 3, which separates a first angle range 8 and a second angle range 9. The closing angle of rotation 10 is represented here in simplified form only as a line, since in the context of the disclosure it is not important from which 0° position the closing angle of rotation 10 is measured, but rather that the closing angle of rotation 10 separates the first angle range 8 from the second angle range 9. The angle of rotation of the output shaft 3 marked by way of example is the actual angle of rotation 11—also represented in simplified form as a line. According to the schematic representation in FIG. 5, this lies in the second angle range 9. If the output shaft 3 is rotated counter to the closing direction of rotation 12, the actual angle of rotation 11 moves out of the second angle range 9, exceeds the closing angle of rotation 10 and reaches the first angle range 8. During normal use of the door, the actual angle of rotation 11 only moves in this first angle range 8.

However, if damage or tampering occurs, in particular on the lever arrangement 103, the output shaft 3 rotates in the closing direction of rotation 12 due to the force exerted by the energy storage device 4 until the actual angle of rotation 11 is detected again in the second angle range 9.

The sensor unit 20 is provided for detecting the actual angle of rotation 11. The exact configuration of the sensor unit 20 is shown in particular in FIGS. 3, 4 and 6 to 12. Accordingly, the sensor unit 20 comprises an encoder fastening 22. The encoder fastening 22 is preferably made of plastic. The encoder fastening 22 is screwed into the fastening receptacle 3.2 of the output shaft 3.

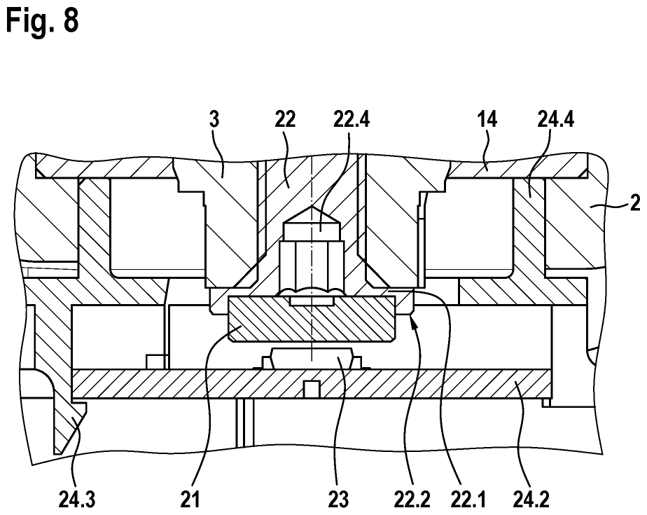

The encoder fastening 22 has a fastening head 22.1 (see FIG. 8). The encoder 21, in particular in the form of a permanent magnet, is fitted, in particular adhered, on this fastening head 22.1.

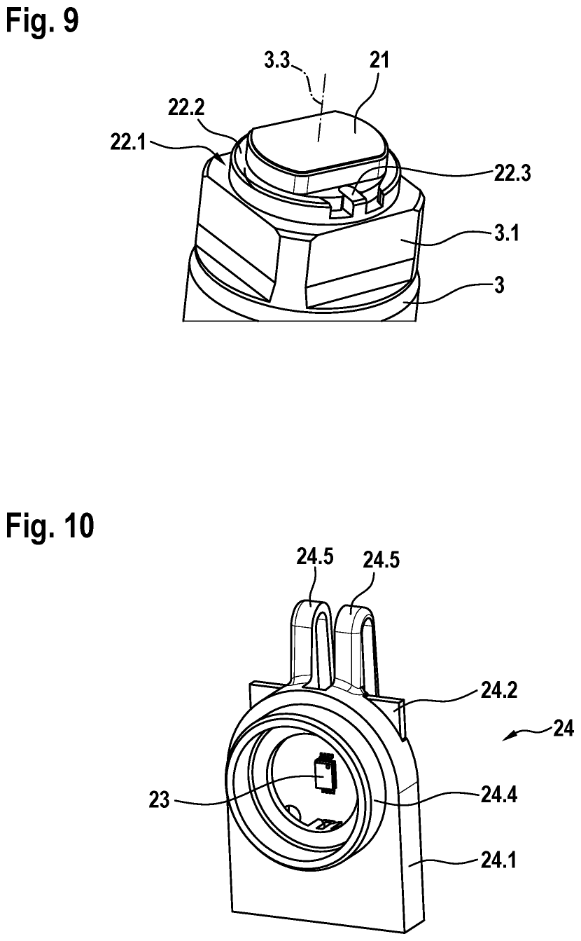

The fastening head 22.1 comprises an edge 22.2 and a form-fitting element 22.3 (see FIG. 9). The edge 22.2 surrounds the encoder 21. The form-fitting element 22.3 and the encoder 21 engage into one another. The edge 22.2 and/or the form-fitting element 22.3 allow the encoder 21 to be positioned precisely relative to the output shaft 3 and thus relative to the axis of rotation 3.3. This in particular ensures that the encoder 21 is arranged symmetrically to the axis of rotation 3.3.

The encoder fastening 22 can have a tool engagement 22.4, which in particular makes it easier to screw the encoder fastening 22 into the fastening receptacle 3.2.

A sensor 23 is located directly next to the encoder 21, but not touching the encoder 21. This sensor 23 is fastened to the end face of the output shaft 3 and thus directly to the encoder 21 by means of a sensor receiving device 24.

The sensor receiving device 24 comprises a bracket 24.1 and a sensor circuit board 24.2. The sensor 23 is located on this sensor circuit board 24.2. The sensor circuit board 24.2 is fastened by means of the bracket 24.1.

The bracket 24.1 has a bracket projection 24.4 (see FIGS. 7, 8, 10). This extends around the output shaft 3 such that the output shaft 3 protrudes into the bracket projection 24.4.

The bracket projection 24.4 is supported axially on the inside against the housing 2, in detail the axle bearing closure 14. This means that the bracket 24.1 rests against the housing 2. Radially outside, the bracket projection 24.4 clamps on an inner surface of the housing 2, whereby the bracket 24.1 is fastened to the housing 2.

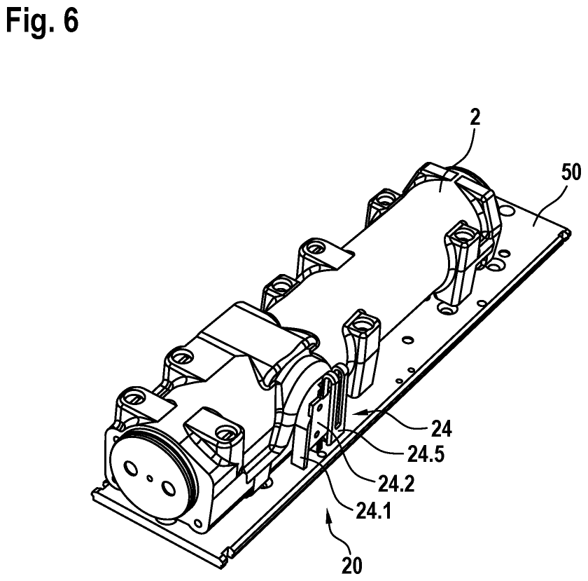

In addition, the figures, in particular FIG. 6, show that the bracket 24.1 has a fastening spring 24.5. The fastening spring 24.5 is located on the inside of the panel 30, whereby the bracket 24.1 is clamped between the panel 30 and the housing 2.

The sensor receiving device 24, in particular the bracket 24.1, has a bracket clip 24.3 (see FIGS. 7 and 8). The sensor circuit board 24.2 is fastened to the bracket 24.1 by means of this bracket clip 24.3.

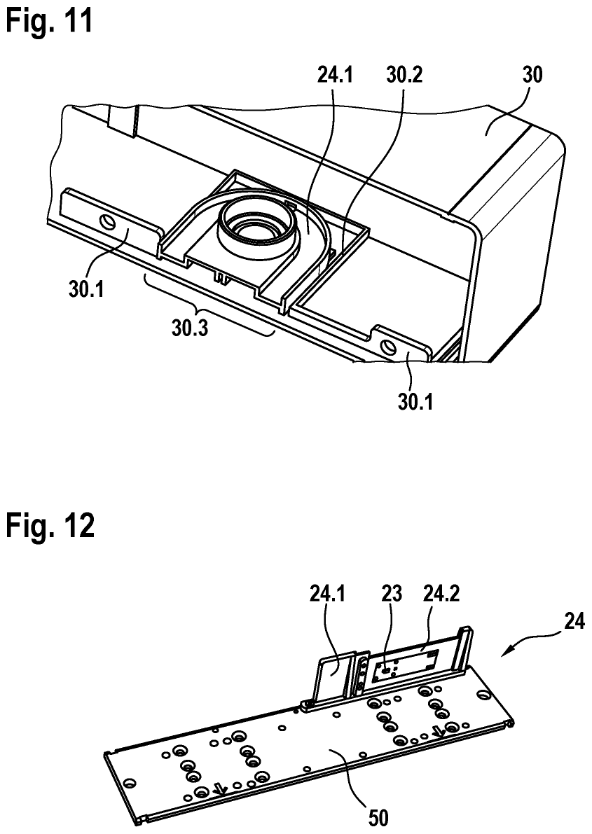

FIG. 11 in particular illustrates that the panel 30 has fastening tabs 30.1. The panel 30 can be fastened, in particular screwed, to the mounting plate 50 by means of these fastening tabs 30.1. Furthermore, FIG. 11 shows that the panel 30 has at least one bracket receptacle 30.2 on the inside. The bracket 24.1 protrudes into this bracket receptacle 30.2. It is in particular provided that a recess 30.3 without fastening tabs 30.1 is provided in the region of the bracket receptacle 30.2. This ensures that the fastening tabs 30.1 do not present an obstacle for the bracket 24.1 when the panel 30 is fitted.

FIG. 12 shows an alternative fastening of the sensor 23. The sensor 23 is also arranged on the sensor circuit board 24.2. The bracket 24.1 receives the sensor circuit board 24.2. However, the bracket 24.1 is designed such that it can be fastened, in particular screwed, directly on the mounting plate 50. This also makes it possible to fasten the sensor 23 directly to the end face of the output shaft 3 and thus directly to the encoder 21.

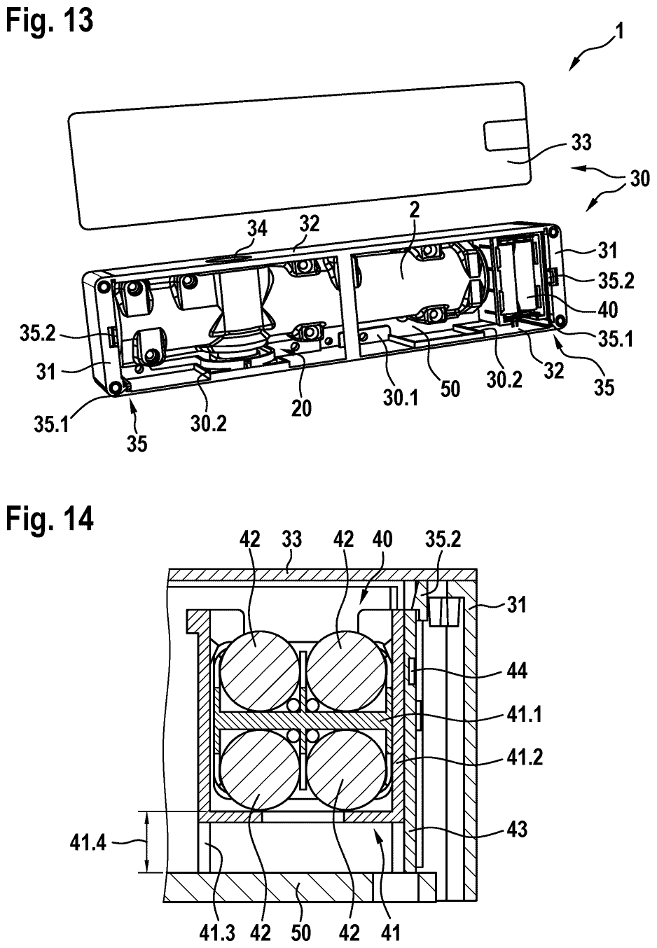

According to FIG. 13, the panel 30 has two opposing end walls 31. The end walls 31 are connected to one another via two opposing side walls 32. It is in particular provided that the two end walls 31 and the two side walls 32 together form the base body of the panel 30. This base body of the panel 30 can be closed by means of a cover 33.

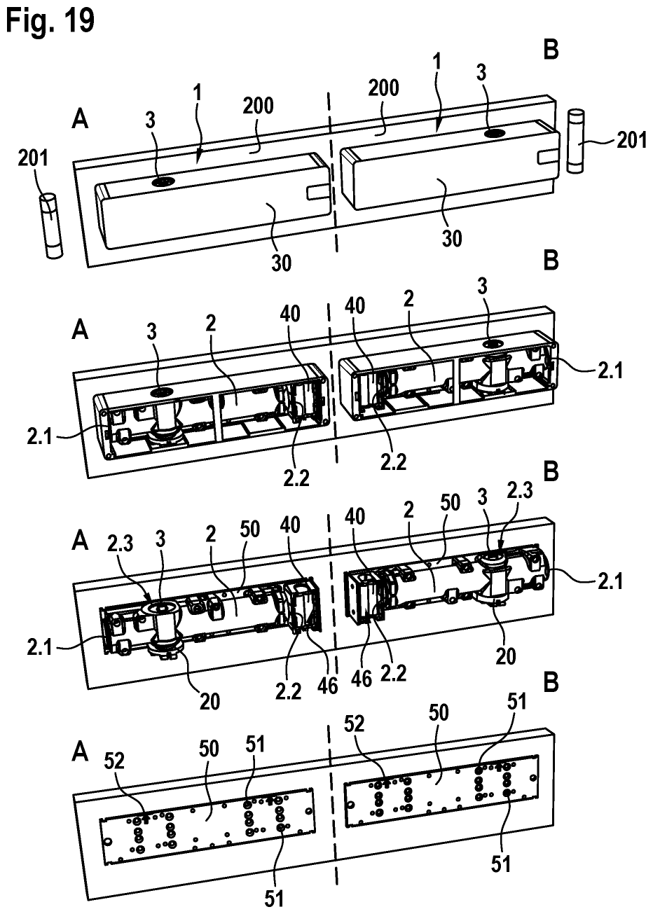

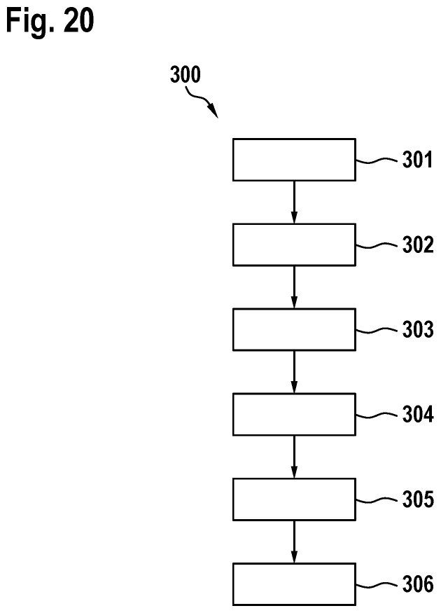

FIG. 13 shows the removed cover 33. It is easy to recognise that the described bracket receptacle 30.2 is doubled on the inside of one of the two side walls 32. This double design of the bracket receptacle 30.2 is used in particular when the housing 2 is changed between a left-sided arrangement A and a right-sided arrangement B, as will be explained in detail on the basis of FIG. 19.

The same applies to the represented axle recess 34 in FIG. 13. In the representation shown, the left axle recess 34 is used to connect the lever arrangement 103 to the output shaft 3. On the right side of the represented panel 30 is also provided an axle recess 34, which is closed, for example, by a blind cover not represented or can be broken out.

Furthermore, FIG. 13 shows the aforementioned module 40 inside the panel 30. This module 40 can also be arranged on both sides of the panel 30 due to the optional left-sided arrangement A and right-sided arrangement B of the housing 2. FIG. 13 therefore shows a module receptacle 35 on both end walls 31 of the panel 30. In the representation according to FIG. 13, the right module receptacle 35 is used. The module receptacle 35 serves as a connecting means.

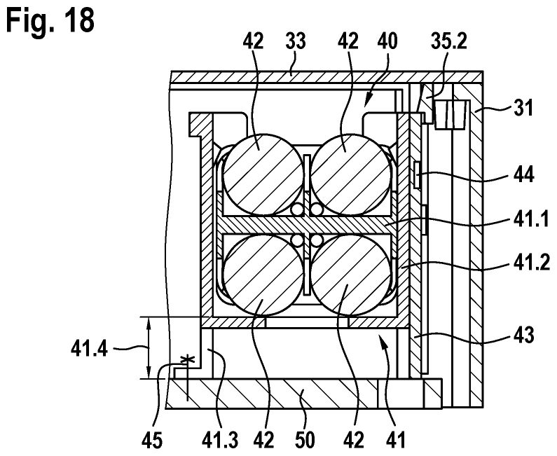

The module receptacle 35 has a module groove 35.1 and a module clip 35.2 in each case. As will be described, the module 40 comprises a module circuit board 43. This can be inserted into the module groove 35.1 and fixed by means of the module clip 35.2. Alternatively (see FIG. 18), the module 40 is fastened, in particular screwed down, on the mounting plate 50. In this alternative, the module groove 35.1 and the module clip 35.2 can be omitted.

The base body with the module receptacle 35 is made of plastic such that when exposed to heat, the base body deforms and thus releases the module 40 such that the module 40 can move away from the door 200.

The module 40 has a housing arrangement 41. According to FIGS. 13 to 15, the housing arrangement 41 comprises an inner housing 41.1 and an outer housing 41.2. The inner housing 41.1 is used to directly receive batteries 42. The inner housing 41.1 is arranged in the outer housing 41.2. The outer housing 41.2 is fastened to the module circuit board 43 and additionally supported against the mounting plate 50 via spacers 41.3.

The spacers 41.3 secure a distance 41.4 (see FIG. 14) between module 40 and mounting plate 50. This distance 41.4 can prove to be advantageous in the event of a fire if the mounting plate 50 is heated via the door 200, as the distance 41.4 prevents the heat from being transferred directly to the module 40 and thus to the batteries 42.

The housing arrangement 41 and the module circuit board 43 are fastened via screws and form a pre-assembled assembly that remains intact when changing from a left-sided to a right-sided arrangement.

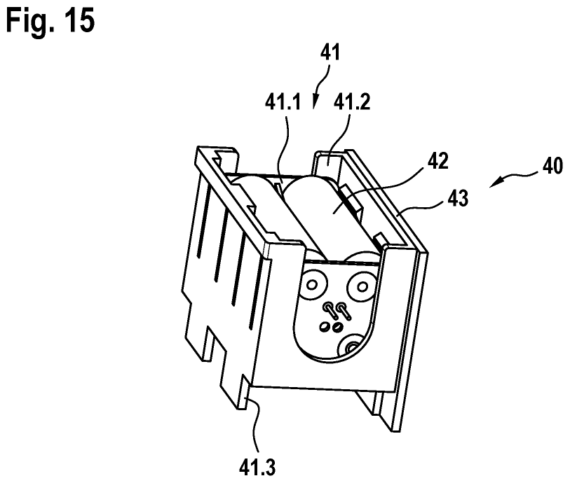

The housing arrangement 41 comprises an opening 46 which, in the installed state, faces forwards towards the user (see FIG. 19). In FIG. 15, the module 40 is rotated such that the opening 46 points obliquely upwards. The user can replace the batteries 42 through the opening 46. In the present exemplary embodiment, the user can remove the inner housing 41.1 with the batteries 42 and replace the batteries 42 and reinsert the inner housing 41.1.

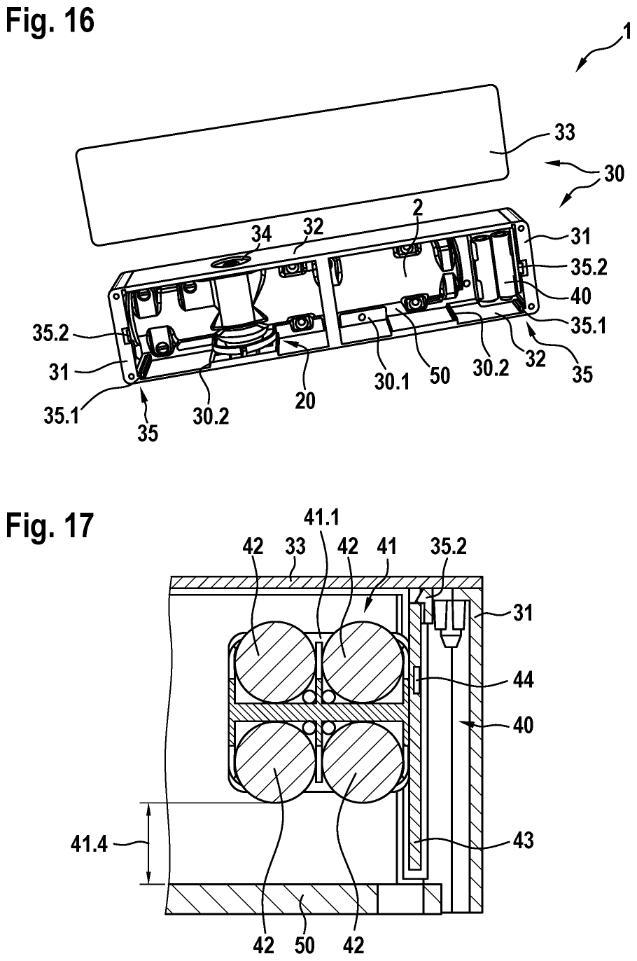

FIGS. 16 and 17 show a variant of the module 40. The housing arrangement 41 only has the inner housing 41.1. The inner housing 41.1 is used to directly receive the batteries 42. The inner housing 41.1 is fastened to the module circuit board 43. The distance 41.4 (see FIG. 17) is also maintained here.

FIG. 18 shows a variant for fastening the module 40 to the mounting plate 50. The housing arrangement 41 is fastened to the mounting plate 50 by means of a housing fastening 45, for example a screw. The screw therefore serves as a connecting means. The module receptacle 35 can also be dispensed with. The module 40 can preferably be fastened to both sides of the mounting plate 50 by means of the housing fastening 45—due to the optional left-sided arrangement A and right-sided arrangement B of the housing 2.

The module 40 can be detached in a non-destructive manner in all the variants represented. For detachment without tools, the module clip 35.2 can be designed to be large enough for manual actuation. The housing fastening 45 can also be detachable without tools, e.g. by means of a wing screw.

As represented purely schematically in FIGS. 14 and 17, 18, the data transmission unit 44 can be located in the module 40, for example in or on the module circuit board 43. In the case of an internal evaluation unit 101, the electronic evaluation unit can be located on the module circuit board 43.

Two halves can be defined on the housing 2, with the first half being assigned to the first end face 2.1 and the second half being assigned to the second end face 2.2. The output shaft 3 is located in the first half and therefore closer to the first end face 2.1 than to the second end face 2.2. The energy storage device 4 is located at least partially in the second half and therefore closer to the second end face 2.2 than to the first end face 2.1.

As illustrated in particular by a combined view of, for example, FIG. 1 and FIG. 3, the first end face 2.1 faces the at least one hinge 201 of the door 200. Accordingly, the second end face 2.2 faces a main closing edge 203 of the door 200.

FIG. 19 illustrates in detail the already mentioned left-sided arrangement A of the door closer 1 and the right-sided arrangement B of the door closer 1. In the four illustrations in FIG. 19, components are gradually hidden in order to represent the complete structure clearly.

For the sake of clarity, FIG. 19 shows both arrangements A and B; in full knowledge that only one of these two arrangements is ever used on a door 200. For orientation, the first representation in FIG. 19 also shows the hinges 201 of the door 200. The first end face 2.1 of the housing 2 and thus half of the housing 2 with the output shaft 3 must always be assigned to these hinges 201.

FIG. 19 basically illustrates that the module 40 is arranged on the mounting plate 50 next to the second end face 2.2 of the housing 2. When changing between the left-sided arrangement A and the right-sided arrangement B, the mounting plate 50 is not rotated. However, there is a change from the first housing orientation. (see third, left-hand illustration of FIG. 19) to a second housing orientation (see third, right-hand illustration of FIG. 19). Here, the housing 2 is rotated by 180° about an axis perpendicular to the longitudinal axis such that the first end face 2.1 and the second end face 2.2 change their left-sided/right-sided orientation. In addition, the housing 2 is rotated about a longitudinal axis of the housing 2 such that the other free end of the output shaft 3 now points upwards. The longitudinal axis is located parallel to door 200.

FIG. 19, third illustration, also shows that the module 40 is located on the second end face 2.2 of the housing 2 in the left-sided arrangement A and in the right-sided arrangement B. The module circuit board 43 always points outwards. This means that the module circuit board 43 and thus the data transmission unit 44 faces away from the housing 2 in both arrangements A, B. As a result, the module circuit board 43 faces the end face 31 in each case. In order to achieve this, the module 40 also changes its orientation from a first module orientation to a second module orientation when changing from a left-sided arrangement A to a right-sided arrangement B. Here, the module 40 is rotated about an axis perpendicular to the door 200. However, there is no rotation about an axis parallel to the door. This ensures that the opening 46 always points forwards towards the user such that the batteries 42 can be easily replaced in both arrangements A, B.

To summarise, it can be seen that the housing 2 and the module 40 are arranged differently in relation to one another in both arrangements A, B. When changing from a left-sided arrangement A to a right-sided arrangement B, the housing 2 and the module 40 are moved independently of one another.

The mounting plate 50, in particular with its fastening elements 51, is designed such that the housing 2 can be fastened on the mounting plate 50 both in the left-sided arrangement A and in the right-sided arrangement B in such manner that the module 40 is always located next to the second end face 2.2.

The mounting plate 50 has a length that substantially corresponds to the length L1 of the housing 2 and to the length L2 of the module 40. In a left-sided arrangement A of the door closer 2 on the door 200, the housing 2 is located more to the left, i.e. on the left side, on the mounting plate 50. In this exemplary embodiment, the housing 2 is even located on the left edge of the mounting plate 50. In a right-sided arrangement B of the door closer 2 on the door 200, the housing 2 is located more to the right, i.e. on the right side, on the mounting plate 50. In this exemplary embodiment, the housing 2 is even located on the right edge of the mounting plate 50. This means that the housing 2 has been moved in relation to the mounting plate 50.

The module 40, on the other hand, is located to the right of the housing 2 in a left-sided arrangement A of the door closer 2 on the door 200. In this exemplary embodiment, the module 40 is even located on the right edge of the mounting plate 50. In a right-sided arrangement B of the door closer on the door 200, the module 40 is located to the left of the housing 2. In this exemplary embodiment, the module 40 is even located on the left edge of the mounting plate 50 (see FIG. 19, third illustration).

In this example, the door closer 1 is fastened to the door 200. In this case, the sensor unit 20 is always located at the lower end of the output shaft 3 in both arrangements A, B. Due to the rotation of the housing 2 about the longitudinal axis, the sensor unit 20 is located at a different free end of the output shaft 3 in the left-sided arrangement A than in the right-sided arrangement B. This means that the sensor arrangement 20 is located on a different housing side in a left-sided arrangement than in a right-sided arrangement.

When the door closer 1 is mounted on the wall 202 or on the frame 202, not represented, the sensor unit 20 is arranged above the housing 2 in a left-sided arrangement A and in a right-sided arrangement B.

As can be seen in FIG. 19, third illustration, the surroundings of the free ends of the output shaft 3 differ from one another. An opening 2.3 around the ends of the output shaft 3 is in particular shaped differently. For this reason, the door closer 1 to be mounted is supplied with two brackets 24.1, one of which is suitable for the left-sided arrangement A and the other for the right-sided arrangement B.

As FIG. 19 shows, for example, the mounting plate 50 can have an orientation indicator 52, for example in the form of arrows. This orientation indicator 52 indicates the orientation with which the mounting plate 50 must be fastened. The last representation in FIG. 19 makes it clear that the orientation indicator 52 is oriented in the same way for both the left-sided arrangement A and the right-sided arrangement B, which means that the mounting plate 50 does not have to be rotated.

To mount the door closer 1, proceed according to the following method 300 according to the disclosure:

In a method step 301, the mounting plate 50 is attached, in particular screwed, to the door 200 at a predefined distance from the hinges 201. In a left-sided arrangement A, the mounting plate 50 is located further to the left on the door 200 than in a right-sided arrangement B.

The housing 2 is then arranged on the mounting plate 50 in a method step 302. In a left-sided arrangement A, the housing 2 is located on the left side of the mounting plate 50; in a right-sided arrangement B, the housing 2 is located on the right side of the mounting plate 50. Here, care is taken to ensure that the housing 2 is oriented according to the first or second housing orientation.

In a next step 303, one of the two brackets 24.1 is selected and the sensor circuit board 24.2 is fastened to the selected bracket 24.1. The bracket 24.1 is then clamped into the lower opening 2.3.

In addition, the panel 30 is prepared in a method step 304. The correct axle recess 34 is produced for this purpose. In addition, the module 40 is inserted into the module receptacle 35 provided for the desired arrangement A, B: In a left-sided arrangement A, the module 40 is inserted into the right module receptacle 35. In a right-sided arrangement B, the module is inserted into the left module receptacle 35. The respectively other module receptacle 35 remains empty. The module 40 has a corresponding module orientation in each case.

Then, in a method step 305, the base body of the panel 30 with the module 40 is fitted on the mounting plate 50. The bracket 24.1 with the fastening spring 24.5 is inserted here into one of the bracket receptacles 30.2. In a left-sided arrangement A, the bracket 24.1 enters the left bracket receptacle 30.2. In a right-sided arrangement B, the bracket 24.1 is arranged in the right bracket receptacle 30.2. The respectively other bracket receptacle 30.2 remains free. The panel 30 is then fastened to the mounting plate 50, e.g. by clipping or screwing. In the method step 305, the module 40 is positioned next to the second end face 2.2 of the housing 2.

In a method step 306, an electrical connection is then established from the sensor unit 20 to the module 40. For example, a plug fastened to a cable is plugged into the module circuit board 43. There is already a connection from the battery 42 to the module circuit board 43. Lastly, the cover 33 is fastened.

The method steps can also be carried out in a different sequence, if physically possible: for example, the bracket 24.1 can be arranged first and then the housing 2 can be fastened to the mounting plate 50 with the bracket, or the electrical connection between the sensor unit 20 and the module 40 can be established first before the panel 30 is placed over the housing 2.

1. A door closer for closing a door, comprising
a housing and an output shaft supported therein, designed for fastening a lever arrangement,
a mechanical energy storage device in the housing, which drives the output shaft to rotate, wherein the energy storage device is preferably a spring,
a module comprising at least one battery and/or a data transmission unit for data transmission,
wherein the housing comprises a first end face, which is to face a hinge of the door when the door closer is mounted,
wherein the housing comprises a second end face which is opposite the first end face,
and wherein the module is arranged next to the second end face of the housing,
wherein the door closer is designed to be arranged in a right-sided and left-sided arrangement on a door or wall, wherein the door closer is designed such that the module is arranged next to the second end face of the housing both in the right-sided and in the left-sided arrangement and is connected at least indirectly to the housing,
wherein the door closer comprises a mounting plate with fastening elements, in particular holes, for fastening, in particular screwing on, the housing,
wherein the mounting plate, the housing and the module are designed such that the housing can be fastened on the mounting plate on the left and right sides without rotating the mounting plate,
wherein in the left-sided arrangement of the housing, the module is located on the right next to the housing above the mounting plate,
and wherein in the right-sided arrangement of the housing, the module is located on the left next to the housing above the mounting plate.

2. The door closer according to claim 1, wherein an arrangement of the module and the arrangement of the housing differ from one another in the right-sided and left-sided arrangement, in particular wherein the door closer comprises connecting means by way of which the module can be arranged in different arrangements in relation to the housing.

3. The door closer according to claim 1, wherein the door closer is designed such that the housing can be arranged, preferably is arranged, on a door in a first housing orientation in a left-sided arrangement and in a second housing orientation, which is rotated relative to the first housing orientation, in a right-sided arrangement; and/or the door closer is designed such that the module can be arranged, preferably is arranged, on a door in a first module orientation in a left-sided arrangement and in a second module orientation, which is rotated relative to the first module orientation, in a right-sided arrangement.

4. The door closer according to claim 1, wherein the door closer is designed such that the data transmission unit is arranged facing away from the housing both in a left-sided and a right-sided arrangement and/or wherein the module comprises a housing arrangement for the battery, wherein the data transmission unit is fixedly connected to the housing arrangement.

5. The door closer according to claim 1, wherein the housing arrangement comprises an opening for replacing the battery, wherein the door closer is designed such that the opening is arranged with the same opening orientation perpendicular to the door, in particular forwards, in the right-sided and left-sided arrangement.

6. The door closer according to claim 1, comprising a sensor, in particular arranged for detecting an encoder fastened to or designed on the output shaft, wherein the sensor is connected to the module for data and/or power transmission, in particular via an electrical line.

7. The door closer according to claim 6, wherein the door closer is designed such that the sensor is arranged next to one side of the housing in the right-sided arrangement and next to an opposing side of the housing in the left-sided arrangement.

8. The door closer according to claim 1, wherein the mounting plate and the housing are designed such that the housing can be fastened on the mounting plate on the left side in one orientation and on the right side in an orientation rotated by 180° and/or wherein the module can be arranged, in particular is fastened, on the mounting plate; preferably wherein the module can be arranged, in particular fastened, on the left side and on the right side on the mounting plate.

9. The door closer according to claim 1, wherein the output shaft is arranged in the half of the housing facing the first end face and/or wherein the energy storage device is arranged between the output shaft and the second end face.

10. The door closer according to claim 1, comprising a panel which covers the housing and the module.

11. The door closer according to claim 10, wherein the module is arranged, in particular fastened, to the panel, preferably to an end wall of the panel, particularly preferably optionally to both end walls of the panel.

12. The door closer according to claim 1, wherein the module is detachable from the panel and/or from the mounting plate, in particular for battery replacement, in a non-destructive manner, preferably detachable without tools.

13. The door closer according to claim 1, wherein the output shaft is exposed on two opposing sides of the housing for optionally fastening a lever arrangement.

14. A method for mounting a door closer, in particular a door closer according to claim 1, wherein the door closer comprises a housing and an output shaft supported therein, wherein the door closer comprises a mechanical energy storage device in the housing, wherein the door closer comprises a module with a housing arrangement for at least one battery and/or with a data transmission unit for data transmission, wherein the method comprises the following steps:
attaching a mounting plate on the left or right side at a predefined distance from hinges of the door,
arranging the housing on the mounting plate such that a first end face of the housing is facing a hinge of the door,
arranging the module next to a second end face of the housing, which is opposite the first end face, wherein in the left-sided arrangement of the housing, the module is located on the right next to the housing above the mounting plate
wherein in the right-sided arrangement of the housing, the module is located on the left next to the housing above the mounting plate.
